(19) United States
(12) Patent Application Publication
(10) Pub. No.: US 2025/0062088 A1
(43) Pub. Date: Feb. 20, 2025

(54) IMPROVED KEY STRUCTURE FOR KEYBOARD

(71) Applicant: Voyetra Turtle Beach, Inc., White Plains, NY (US)

(72) Inventor: Wei Chuan WANG, New Taipei City (TW)

(73) Assignee: Voyetra Turtle Beach, Inc., White Plains, NY (US)

(21) Appl. No.: 18/723,027

(22) PCT Filed: Dec. 19, 2022
(86) PCT No.: PCT/US2022/081899

§ 371 Date: Jun. 21, 2024

(30) Foreign Application Priority Data
Dec. 23, 2021 (TW) 110215323
Dec. 28, 2021 (CN) 202123331266.9

(51) Int. Cl. H01H 13/86; H01H 13/83

(52) U.S. Cl. CPC H01H 13/86; H01H 13/83

(57) ABSTRACT

An improved key structure for a keyboard may be installed on a keyboard iron plate and comprises lower housing and upper housings. The lower housing includes a lower peripheral wall which includes a lower bulge portion thereon, both side surfaces of the lower peripheral wall include a pair of elastic arms thereon that include a latching portion and a pulling portion thereon. The upper housing is assembled on the lower housing, and includes an upper bulge portion. The elastic arms extend from the bottom of the lower housing, the tops of the elastic arms are aligned with an upper surface of the lower bulge portion, and two sides of the elastic arms abut against the lower peripheral wall, so that the insertion force of the key structure is small, and the key structure is firmly buckled on the keyboard iron plate with a large buckling force.

### CROSS-REFERENCE TO RELATED APPLICATIONS

This application claims the benefit of Taiwan Patent Application No. 110215323, filed Dec. 23, 2021 (which issued as Taiwan Patent No. M628522 on Jun. 21, 2022), and Chinese Patent Application No. 202123331266.9, filed Dec. 28, 2021 (which issued as Chinese Patent No. ZL 202123331266.9 on Aug. 9, 2022), which are hereby incorporated herein by reference in their entirety.

### TECHNICAL FIELD

The present utility model relates to a key structure, and in particular, to an improved key structure that can be installed or detached on an iron plate of a keyboard without any leakage.

### BACKGROUND ART

The situation of gaming is changing rapidly. If someone always loses battles due to mistakes and holds grudges against them, in addition to his own skill being not as good as others, it is bound to increase the requirements of computer peripheral accessories, and the keyboard is a critical part.

In use, the keyboard is different from the comfortable feel pursued by usual work and document processing. On the other hand, the gaming keyboard needs to truly reflect the player's actions in the fierce battle. However, there are many kinds of keyboards advertised as e-sports on the market. In addition to mechanical keyboards with different feel such as green switches, red switches, etc., the specifications in terms of wired and wireless, price, additional functions, etc. are also different, which makes it difficult for players from all walks of life to choose.

At present, a detachable key structure includes a lower housing, an upper housing and a pressing mechanism installed between the upper housing and the lower housing. A pair of elastic arms are provided on two sides of the lower housing. After the upper housing, the pressing mechanism and the lower housing of the key structure are assembled, the elastic arms on two sides of the lower housing can be used to install the key structure in a socket of an iron plate of the keyboard.

Since the above-mentioned elastic arms are designed to extend from top to bottom to the bottom of the lower housing, when the key structure is installed and inserted into the socket of the keyboard iron plate, the generated insertion force is large, and it is not easy to let the pair of elastic arms of the lower housing be inserted into the socket. In addition, after the key structure is inserted into the socket of the keyboard iron plate, the elastic arms and the socket generate a small buckling force. Therefore, after being installed and used for a period of time, the key structure is also prone to loosening. Moreover, because the elastic arms are designed to extend downward from an upper bulge portion to the bottom of the lower housing, the keyboard iron plate has a gap larger than the upper bulge portion. Therefore, when the light source at the bottom of the keyboard is projected to the upper housing to guide light from bottom to top, light leakage is likely to occur in the gap.

### Summary of the Utility Model

Therefore, a main objective of the present utility model is to solve the above-mentioned defects. In the present utility model, the elastic arms of the key structure are redesigned, and the elastic arms are designed to extend upward from the bottom of the lower housing, so that when the key structure is inserted into the socket of the keyboard iron plate, the insertion force of the key structure is small, and the key structure is firmly buckled on the keyboard iron plate with a large buckling force.

In order to achieve the above-mentioned objective, the present utility model provides an improved key structure, which is installed on a keyboard iron plate and comprises a lower housing and an upper housing. The lower housing has a lower peripheral wall thereon, the lower peripheral wall has a lower bulge portion thereon, two sides of the lower peripheral wall have a pair of openings, the pair of openings each have an elastic arm thereon, and the pair of elastic arms each have a latching portion and a pulling portion thereon. The upper housing is assembled on the lower housing, the upper housing has an upper peripheral wall thereon, and the peripheral wall has an upper bulge portion thereon. The elastic arms extend from bottom to top from the bottoms of the pair of openings of the lower housing, the tops of the pair of elastic arms are aligned with an upper surface of the lower bulge portion, and two sides of the pair of elastic arms abut against two sides of the pair of openings.

In an embodiment of the present utility model, the lower peripheral wall is provided with an installation space for installing a pressing mechanism in a surrounding manner, one side of the lower bulge portion has a pair of symmetrical through holes, the upper surface and lower surface of the lower bulge portion have a pair of convex portions, and the upper surface of the lower bulge portion has a positioning column and a positioning hole.

In an embodiment of the present utility model, the bottom of each of the elastic arms has a penetrating hole, the penetrating hole allows a light source generated by a light-emitting element to pass through, and there are a pair of symmetrical accommodation spaces between the installation space and the pair of elastic arms.

In an embodiment of the present utility model, the pressing mechanism is installed in the installation space, and includes a base, a first elastic element, a pressing shaft and a second elastic element.

In an embodiment of the present utility model, the base has a protruding column thereon, the first elastic element is sleeved on the protruding column, and the pressing shaft is sleeved on the first elastic element; a top surface of the pressing shaft has a shaft portion, and two side surfaces thereof are each provided with a guide slider; and the second elastic element is arranged on one side of the pressing shaft to assist the pressing shaft to act up and down.

In an embodiment of the present utility model, the upper housing is made of transparent or translucent plastic, the upper peripheral wall of the upper housing is provided with an action space for accommodating the action of the pressing shaft in a surrounding manner, and a top surface of the upper peripheral wall has a via hole communicating with the action space.

In an embodiment of the present utility model, a lower surface of the upper bulge portion has a positioning column and a positioning hole, and when the upper housing and the lower housing are assembled, the positioning column and the positioning hole of the upper housing are symmetrically assembled with the positioning hole and the positioning column of the lower housing.

In an embodiment of the present utility model, the upper bulge portion on two sides of the upper housing has a pair of notches thereon, the pair of notches are each extended downward with a buckle portion so that the buckle portions pass through the pair of through holes, the pair of buckle portions are buckled on the convex portion on the lower surface of the lower bulge portion, and the pair of notches are fixed on the convex portion on the upper surface of the lower bulge portion.

In an embodiment of the present utility model, two sides of the upper bulge portion of the upper housing have a pair of symmetrical light guide portions, side surfaces of the pair of light guide portions facing the action space each have a guide rail thereon, and the guide rails are used for allowing the guide sliders on two sides of the pressing shaft to slide.

### BRIEF DESCRIPTION OF DRAWINGS

FIG. 1 is a three-dimensional schematic view of the appearance of a key structure of the present utility model;

FIG. 2 is an exploded schematic view of the key structure of the present utility model;

FIG. 3 is a side schematic view of the key structure of the present utility model;

FIG. 4 is a top schematic view of the key structure of the present utility model being installed on a keyboard iron plate;

FIG. 5 is a cross-sectional schematic view of FIG. 4 at position 5-5;

FIG. 6 is a cross-sectional schematic view of FIG. 4 at position 6-6;

FIG. 7 is a schematic view of the action of the key structure of the present utility model being detached from the keyboard iron plate.

In the figures:
key structure 10; lower housing 1; lower peripheral wall 11; installation space 12; lower bulge portion 13; positioning column 131; positioning hole 132; through hole 14; convex portion 15, 15a; elastic arm 16; latching portion 161; pulling portion 162; penetrating hole 163; accommodation space 17; opening 18; pressing mechanism 2; base 21; protruding column 211; first elastic element 22; pressing shaft 23; shaft portion 231; guide slider 232; second elastic element 24; upper housing 3; upper peripheral wall 31; action space 32; via hole 33; upper bulge portion 34; positioning column 341; positioning hole 342; notch 35; buckle portion 36; light guide portion 37; guide rail 371; keyboard iron plate 20; and socket 201.

### DETAILED DESCRIPTION OF PREFERRED EMBODIMENTS

The present utility model will be further described below in conjunction with accompanying drawings and specific embodiments, so that the present utility model can be better understood and can be implemented by a person skilled in the art, but the embodiments given are not intended to limit the present utility model.

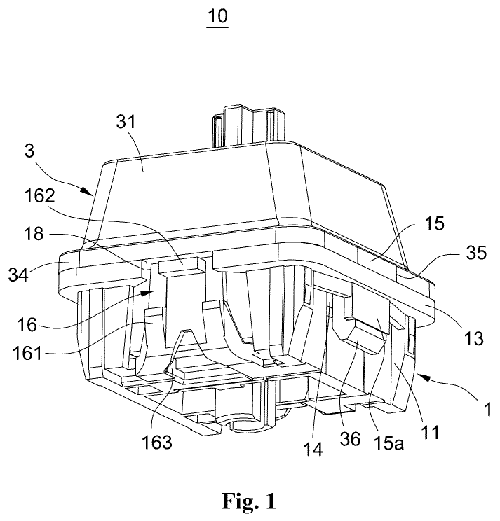

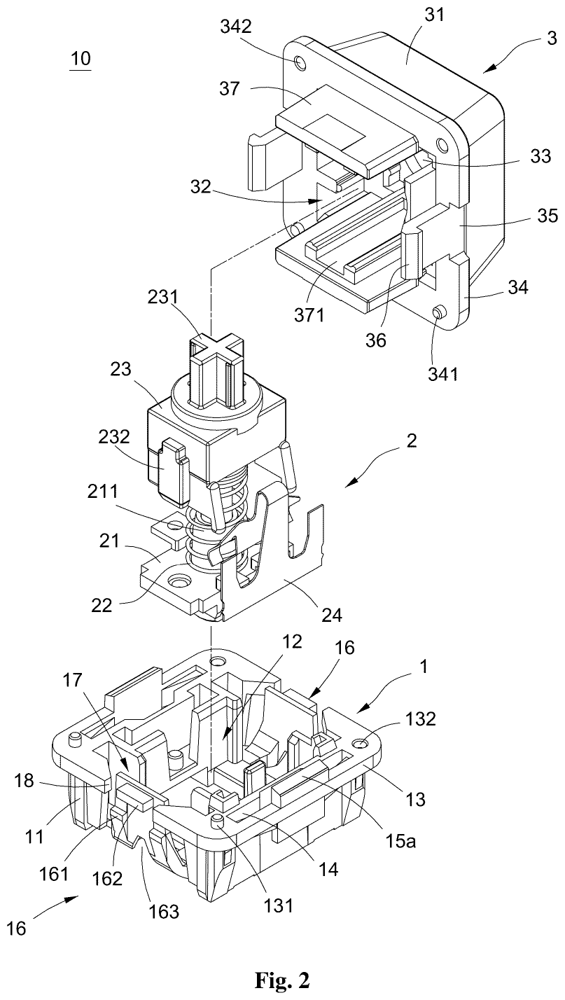

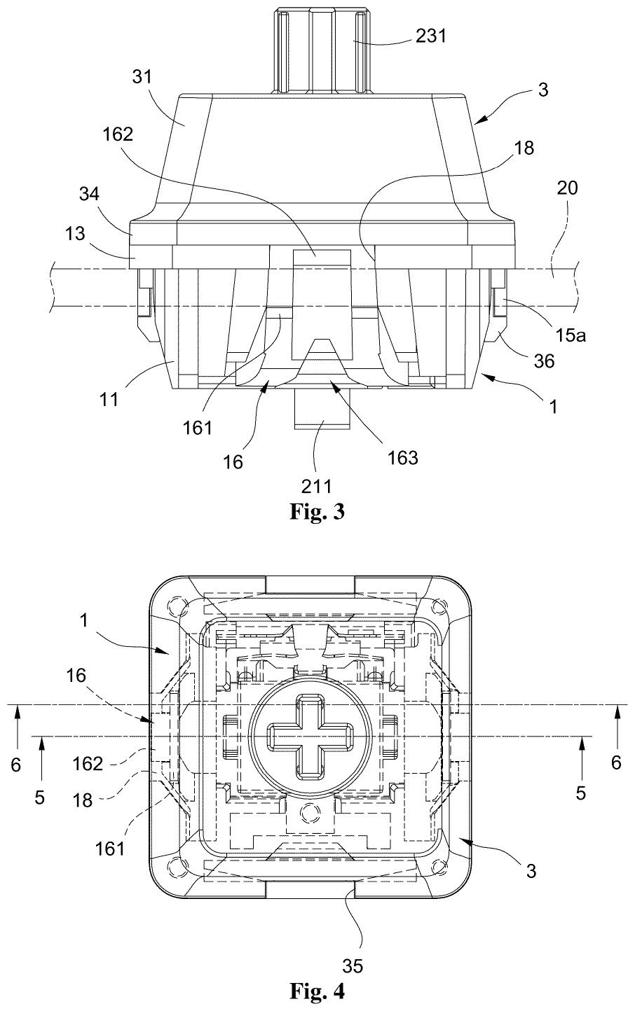

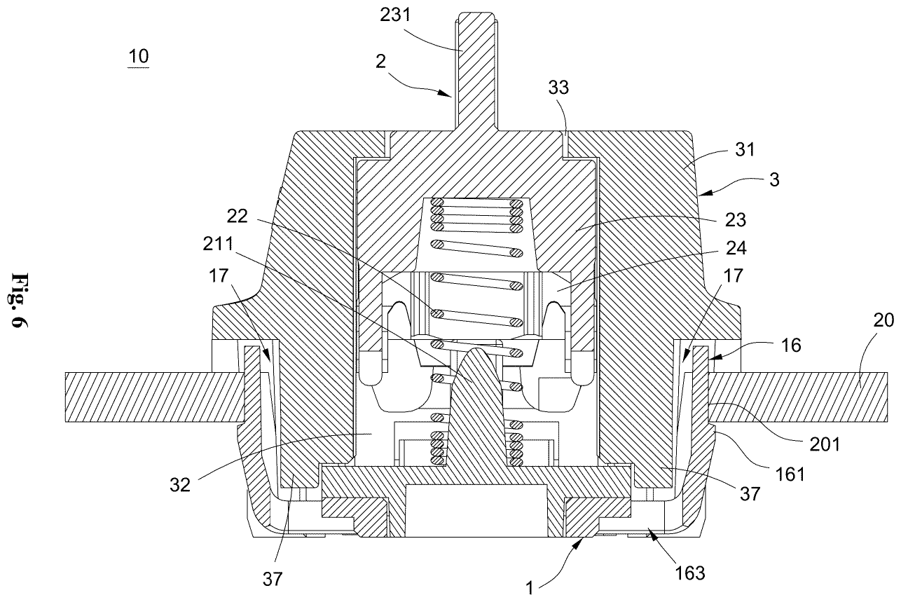

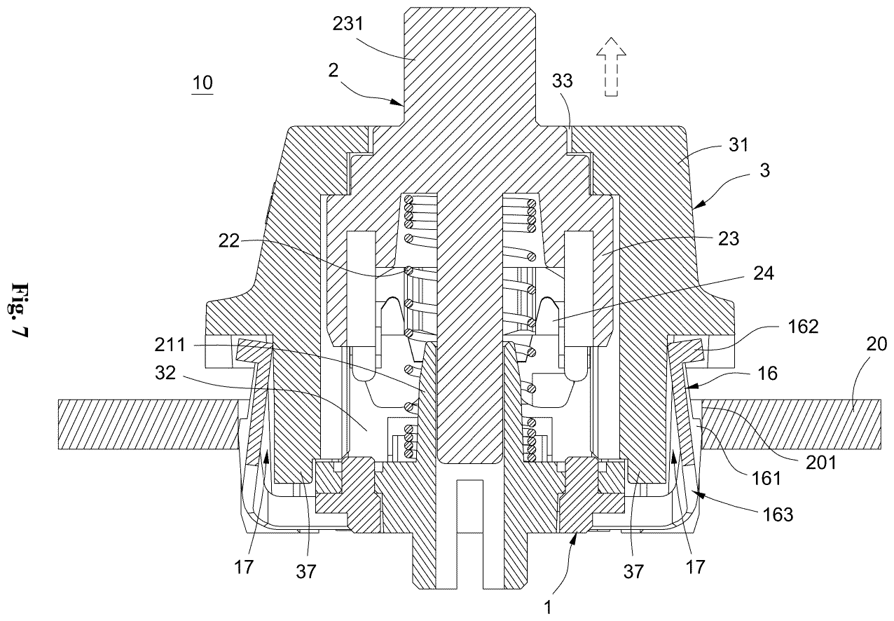

Please refer to FIGS. 1 to 6, which are three-dimensional, exploded, and side schematic views of the appearance of a key structure of the present utility model, and cross-sectional schematic views thereof at positions 4-4 and 5-5 of FIG. 3. As shown in the figures, in the improved key structure of the present utility model, the key structure 10 comprises a lower housing 1, a pressing mechanism 2 and an upper housing 3.

The lower housing 1 has a lower peripheral wall 11 thereon. The lower peripheral wall 11 is provided with an installation space 12 for installing the pressing mechanism 2 in a surrounding manner, and the periphery of the lower peripheral wall 11 has a lower bulge portion 13. Two sides of the lower bulge portion 13 have a pair of symmetrical through holes 14. The pair of through holes 14 are used for allowing two buckle portions 36 of the upper housing 3 to pass through and assemble. An upper surface and a lower surface of the lower bulge portion 13 have a pair of convex portions 15, 15a, and the upper surface of the lower bulge portion 13 has a positioning column 131 and a positioning hole 132. The pair of convex portions 15, 15a, and the positioning column 131 and the positioning hole 132 are used for assembly and positioning of the upper housing 3.

In addition, there are a pair of symmetrical openings 18 on the other two sides of the lower housing 1, and the bottoms of the pair of openings include a pair of elastic arms 16 extending from bottom to top, so that the tops of the pair of elastic arms 16 located on a top surface of a keyboard iron plate 20 are aligned with the upper surface of the bulge portion 13 of the lower peripheral wall 11, and two sides of the pair of elastic arms 16 abut against two sides of the pair of openings 18 of the lower peripheral wall 11 (as shown in FIG. 3). As a result, the insertion force of the key structure is small, and the key structure is firmly buckled on the keyboard iron plate 20 with a large buckling force. Further, one side surface of each of the pair of elastic arms 16 includes a latching portion 161 and a pulling portion 162. The latching portion 161 is latched to a bottom surface of a socket 201 of the keyboard iron plate 20. The pulling portion 162 is latched to a top surface of the socket 201 of the keyboard iron plate 20. As long as the pulling portion 162 is pulled to inwardly retract the elastic arm 16 toward the lower peripheral wall 11 and separate the latching portion 161 from the bottom surface of the socket 201 of the keyboard iron plate 20, the key structure 10 can be detached from the keyboard iron plate 20. Still further, the bottom of the elastic arm 16 has a penetrating hole 163, and the penetrating hole 163 allows a light source generated by a light-emitting element (not shown in the figures) installed below the keyboard iron plate 20 to pass through. Furthermore, there are a pair of symmetrical accommodation spaces 17 between the installation space 12 and the pair of elastic arms 16, and the accommodation spaces 17 are used for accommodating a light guide portion 37 of the upper housing 3.

The pressing mechanism 2 is installed in the installation space 12 of the lower housing 1, and includes a base 21, a first elastic element 22, a pressing shaft 23 and a second elastic element 24. The base 21 has a protruding column 211 thereon, the first elastic element 22 is sleeved on the protruding column 211, the pressing shaft 23 is sleeved on the first elastic element 22, and the first elastic element 22 is used for causing the pressing shaft 23 to move up and down when the pressing shaft 23 is pressed by an external force. The pressing shaft 23 has a shaft portion 231 on a top surface and a guide slider 232 on each of two side surfaces, so that when the pressing shaft 23 is pressed, the guide slider 232 can slide on a guide rail 371 on one side surface of the light guide portion 37 of the upper housing 3. The second elastic element 24 is arranged on one side of the pressing shaft 23 to assist the pressing shaft 23 to act up and down. In the figures, the first elastic element 22 is a spring, and the second elastic element 24 is a leaf spring.

The upper housing 3 is made of transparent or translucent plastic, and is assembled on the lower housing 1. The upper housing 3 has an upper peripheral wall 31 thereon, and the upper peripheral wall 31 is provided with an action space 32 for accommodating the action of the pressing shaft 23 in a surrounding manner. A top surface of the upper peripheral wall 31 has a via hole 33 communicating with the action space 32. In addition, the upper peripheral wall 31 has an upper bulge portion 34 thereon, and a lower surface of the upper bulge portion 34 has a positioning column 341 and a positioning hole 342. When the upper housing 3 and the lower housing 1 are assembled, the positioning column 341 and the positioning hole 342 of the upper housing 3 are symmetrically positioned and assembled with the positioning hole 132 and the positioning column 131 of the lower housing 1. Further, the upper bulge portion 34 on two sides of the upper housing 3 has a pair of notches 35 thereon. The pair of notches 35 are each extended downward with a buckle portion 36, so that the buckle portions 36 pass through the pair of through holes 14 of the lower housing 1. The pair of buckle portions 36 are buckled on convex portions 15a on the lower surface of the lower bulge portion 13, and the pair of notches 35 of the upper housing 3 are fixed on convex portions 15 on the upper surface of the lower bulge portion 13.

Still further, two sides of the upper bulge portion 34 of the upper housing 3 have a pair of light guide portions 37 that are symmetrical and installed in the accommodation space 17, and the pair of light guide portions 37 can guide a light source generated by a light-emitting element (not shown in the figures) installed at the bottom of the keyboard into the entire upper housing 3, so that the entire upper housing 3 is illuminated. A guide rail 371 is provided on each of the side surfaces of the pair of light guide portions 37 facing the action space 32, and the guide rails 371 are used for allowing guide sliders 232 on two sides of the pressing shaft 23 to slide, so that the pressing shaft 23 can be stably moved up and down.

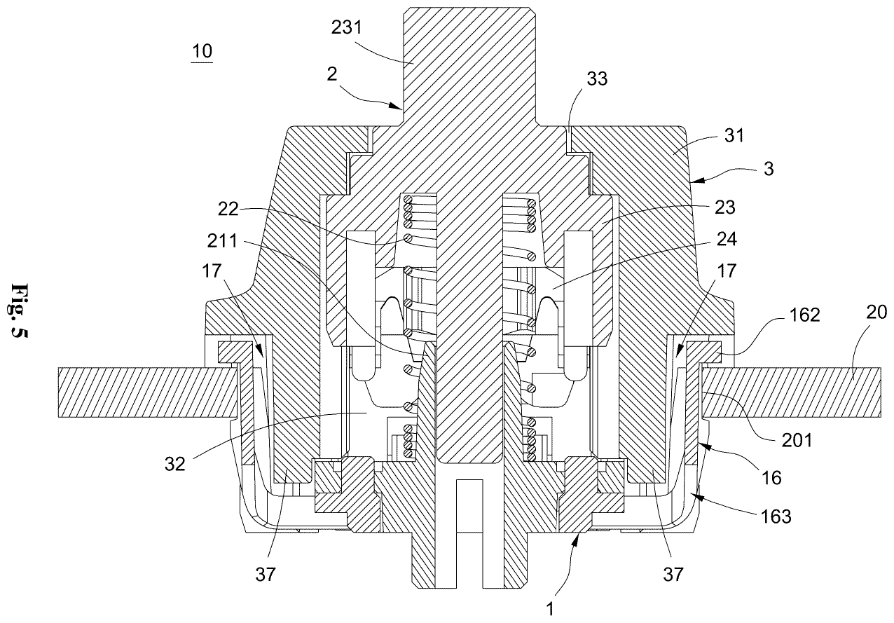

Please refer to FIGS. 4 to 6, which are a top schematic view of the key structure of the present utility model being installed on the keyboard iron plate, cross-sectional schematic views thereof at positions 4-4 and 5-5 of FIG. 3, and a schematic view of the action of the key structure being detached from the keyboard iron plate. As shown in the figures, after the lower housing 3, the pressing mechanism 2 and the upper housing 1 of the key structure 10 of the present utility model are assembled in sequence, the lower housing 1 is squeezed into the socket 201 of the keyboard iron plate 20. The socket 201 will squeeze the pair of elastic arms 16 of the lower housing 1 to inwardly retract the elastic arms 16 toward the lower peripheral wall 11. Since the elastic arms 16 are designed to extend from bottom to top from the bottom of the lower housing 1, the insertion force of the key structure 10 into the socket 201 of the keyboard iron plate 20 is small, so that when the latching portion 161 of the elastic arm 16 is no longer pressed by the socket 201, the elastic arm 16 bounces open. As a result, the latching portion 16 is latched on the bottom surface of the socket 201 to generate a strong buckling force, so that the key structure 10 can be firmly inserted into the socket 201 of the keyboard iron plate 20.

When the key structure 10 needs to be detached, replaced or re-installed, the pulling portion 162 of the elastic arm 16 is pulled to inwardly retract the elastic arm 16 toward the lower peripheral wall 11 of the lower housing 1 and separate the latching portion 161 from the bottom surface of the socket 201 of the keyboard iron plate 20, so that the key structure 10 can be detached from the socket 201 of the keyboard iron plate 20, thereby allowing an installer to easily disassemble, replace or repair.

The embodiments described above are only preferred embodiments for fully illustrating the present utility model, and the scope of protection of the present utility model is not limited thereto. Equivalent substitutions or transformations made by a person skilled in the art on the basis of the present utility model are all within the scope of protection of the present utility model. The scope of protection of the present utility model is subject to the claims.

1. An improved key structure, comprising:
a lower housing comprising a lower peripheral wall, wherein the lower peripheral wall comprises a lower bulge portion, two sides of the lower peripheral wall comprise a pair of openings, the pair of openings further comprising a pair of elastic arms, and the pair of elastic arms each comprise a latching portion and a pulling portion; and
an upper housing assembled on the lower housing, wherein the upper housing comprises an upper peripheral wall, and the upper peripheral wall comprises an upper bulge portion;
wherein the elastic arms extend from bottom to top from the bottom of the lower housing, the tops of the pair of elastic arms are aligned with an upper surface of the lower bulge portion, and two sides of the pair of elastic arms abut against two sides of the pair of openings of the lower peripheral wall.

2. The improved key structure as claimed in claim 1, wherein the lower peripheral wall further comprises an installation space within which to install a pressing mechanism in a surrounding manner, one side of the lower bulge portion comprises a pair of symmetrical through holes, an upper surface and lower surface of the lower bulge portion comprise a pair of convex portions, and the upper surface of the lower bulge portion comprises a positioning column and a positioning hole.

3. The improved key structure as claimed in claim 2, wherein the bottom of each of the elastic arms comprises a penetrating hole, the penetrating hole allows a light source generated by a light-emitting element to pass through, and wherein a pair of symmetrical accommodation spaces are provided between the installation space and the pair of elastic arms.

4. The improved key structure as claimed in claim 2, wherein the pressing mechanism is disposed in the installation space, and includes a base, a first elastic element, a pressing shaft and a second elastic element.

5. The improved key structure as claimed in claim 2, wherein a base of a pressing mechanism comprises a protruding column, a first elastic element is sleeved on the protruding column, and a pressing shaft is sleeved on the first elastic element; a top surface of the pressing shaft comprises a shaft portion, and two side surfaces thereof are each provided with a guide slider; and a second elastic element is arranged on one side of the pressing shaft to assist the pressing shaft to act up and down.

6. The improved key structure as claimed in claim 5, wherein the upper housing is at least partially made of transparent or translucent material, the upper peripheral wall of the upper housing further comprises an action space that accommodates action of the pressing shaft in a surrounding manner, and a top surface of the upper peripheral wall comprises a via hole communicating with the action space.

7. The improved key structure as claimed in claim 6, wherein a lower surface of the upper bulge portion comprises a positioning column and a positioning hole, and when the upper housing and the lower housing are assembled, the positioning column and the positioning hole of the upper housing are symmetrically assembled with the positioning hole and the positioning column of the lower housing.

8. The improved key structure as claimed in claim 7, wherein the upper bulge portion on two sides of the upper housing comprises a pair of notches, the pair of notches are each extended downward with a buckle portion so that the buckle portions pass through the pair of through holes, the pair of buckle portions are buckled on the convex portion on the lower surface of the lower bulge portion, and the pair of notches are fixed on the convex portion on the upper surface of the lower bulge portion.

9. The improved key structure as claimed in claim 8, wherein two sides of the upper bulge portion of the upper housing comprise a pair of symmetrical light guide portions, side surfaces of the pair of light guide portions facing the action space each comprise a guide rail, and the guide rails are used for allowing the guide sliders on two sides of the pressing shaft to slide.
